(19) United States
(12) Patent Application Publication
(10) Pub. No.: US 2018/0087554 A1
(43) Pub. Date: Mar. 29, 2018

(54) UNTHREADED PIN ASSEMBLY FOR FORMING A PIN JOINT

(71) Applicant: TentCraft, Inc., Traverse City, MI (US)

(72) Inventors: Jonathan Dreher, Williamsburg, MI (US); Thomas R. Burpee, Traverse City, MI (US)

(21) Appl. No.: 15/716,615

(22) Filed: Sep. 27, 2017

Related U.S. Application Data
(60) Provisional application No. 62/400,291, filed on Sep. 27, 2016.

(51) Int. Cl. F16B 21/12

(52) U.S. Cl. CPC F16B 21/12; F16B 2021/14

(57) ABSTRACT

An improved pin assembly for forming at least one pin joint in an object. The pin assembly may be readily inserted into and removed from more than one object when forming a pin joint, without the need for any special tools or equipment. The pin assembly comprises an unthreaded, self-locking pin comprising a first end and a second end; an elongated shaft; a hole intersecting the shaft; and a fin slidably disposed in the hole. The self-locking pin is configured to be readily inserted into and readily removed from an object, wherein the object comprises at least one first aperture on at least one first space frame member and at least on second aperture on at least one second space frame member. The fin is in its extended position after the self-locking pin is inserted through both the first space frame member and the second space frame member.

### PRIORITY CLAIM

This patent application is a Non-Provisional patent application and claims priority under 35 U.S.C. 119(e) to United States Provisional Patent Application Ser. No. 62/400,291, titled “METHOD AND APPARATUS FOR FORMING A PIN JOINT,” filed Sep. 27, 2016. The entire disclosure of the aforementioned patent application is incorporated by reference as if fully stated herein.

### FIELD

This patent application generally relates to a method for forming a pin joint using an unthreaded pin/fastener assembly. Specifically, this patent application relates to a method for forming a pin joint on a tent frame using an unthreaded pin/fastener assembly.

### BACKGROUND

Self-locking pins and fasteners having detents, plungers, or fins that are meant to control the pin's insertion and removal from structures are known. Some commonly used self-locking pins cannot be easily removed (or removed at all) when passing through more than one object, such as a wall or space frame. Due to large shaft diameters on the ends of the pins, the detent/plunger/fin often fails to remain below the pin's shaft when the pin passes through more than one object. As a result, the detent/plunger/fin catches on holes and cause the pins to become permanently stuck. Therefore, a mechanism is needed that may limit the movement of a self-locking pin, while improving the ease of its removability from holes located in these objects.

Other commonly used self-locking pins and fasteners are specifically designed to form pin joints between objects to provide single-axis rotation function in structures such as folding mechanisms, door hinges, and other uniaxial rotation devices. One such example involves a threaded fastener having an unthreaded shoulder. This type of fastener comprises either a nut or binding post that can be threaded directly into a component, such as a connector. However, the installation and removal of the threaded fastener is cumbersome as it requires a tool and involves more time and effort from the user during assembly. Also, the threaded fastener may easily become cross-threaded during assembly and may require thread locking to ensure that the threads don't become loose over time. Due to the threading directly into the connector, the connector becomes significantly more difficult and expensive to manufacture.

An additional example involves pressing and holding an unthreaded pin in place with another component through friction fit or press fit. However, special tools and additional components are required to install and remove the unthreaded pin. Additional components are needed to provide the necessary friction fit to hold the unthreaded pin in place. In some instances, users are required to replace existing parts of an assembly, such as a tent, since it becomes virtually impossible to remove the unthreaded pin, even with special tools.

Thus, there is a need for a self-locking, unthreaded pin/fastener assembly that may be readily inserted into and removed from more than one object when forming a pin joint. In particular, there is a need for a more convenient, accurate, cost-efficient, and time-efficient solution for forming a pin joint using an unthreaded pin/fastener assembly.

### SUMMARY

What is provided is an improved pin assembly for forming at least one pin joint in an object. The improved pin assembly is easier to use, more time-efficient, and more cost-efficient than existing unthreaded pin/fastener assemblies. The pin assembly may be readily inserted into and removed from more than one object when forming a pin joint, without the need for any special tools or equipment. The pin assembly provides a self-locking solution for situations where a nut cannot be applied to the threaded end of a pin due to a lack of access on the opposing side of objects.

In exemplary embodiments, the pin assembly comprises an unthreaded, self-locking pin comprising a first end and a second end; an elongated shaft; a hole intersecting the shaft; and a fin slidably disposed in the hole. The unthreaded, self-locking pin is configured to be readily inserted into and readily removed from an object, wherein the object comprises at least one first aperture on at least one first space frame member and at least on second aperture on at least one second space frame member. The fin is in its extended position after the unthreaded, self-locking pin is inserted through both the first space frame member and the second space frame member so that the unthreaded, self-locking pin is retained in the apertures of the object.

In exemplary embodiments, either the first aperture of the second aperture is a double diameter hole, wherein the double diameter hole is the last aperture through which the unthreaded, self-locking pin is inserted. Due to the presence of the double diameter hole, no washer is not required to secure the unthreaded, self-locking pin. By eliminating the washer, while still maintaining the desired functionality of the unthreaded, self-locking pin, a significant reduction in the amount of money, time, and labor is achieved through the use of the unthreaded, self-locking pin to form pin joints in the assembly of collapsible structures, such as tents, canopies, shelters, pavilions, awnings, and the like.

In other exemplary embodiments, the unthreaded pin assembly further comprises a washer disposed on the first end of the shaft, proximate to the fin. The washer comprises an outer diameter that is larger than the diameter of the first end of the shaft and larger than the diameter of apertures on objects that the unthreaded pin assembly is being inserted through to ensure that the washer does not move through the apertures. The washer further comprises an opening with an inner diameter having the same diameter as that of first end of the shaft and a smaller diameter than the diameter of apertures on objects in which the unthreaded pin assembly is being inserted. In order to prevent the fin from passing through the inner diameter without it being depressed by a user, the inner diameter must be smaller than the fin in its extended (non-depressed) position.

The insertion of the unthreaded pin assembly into both the first component and the second component forms the pin joint and allows the first component to pivot about its end in the second component. By physically engaging with the inner diameter of the washer, the fin can retain the unthreaded pin assembly within the apertures of the first component and the second component during the insertion process. The unthreaded pin assembly may be removed from the first component and the second component by depressing the fin, removing the washer, and sliding the unthreaded pin assembly out of the first component and the second component. The smaller diameter of the first end of the unthreaded pin assembly ensures that the fin remains retracted below the shaft and will not catch on the aperture in the first component or the aperture in the second component.

### BRIEF DESCRIPTION OF THE DRAWINGS

FIG. 1 is a perspective view of an exemplary unthreaded pin assembly according to the invention disclosed herein;

FIG. 2 is an exploded perspective view of the unthreaded pin assembly of FIG. 1;

FIG. 3 is a top plan view of the unthreaded pin assembly shown in FIG. 1;

FIG. 4 is an end elevation view of the unthreaded pin assembly of FIG. 1;

FIG. 5 is another end elevation view of the unthreaded pin assembly of FIG. 1;

FIG. 6 is a perspective view of the unthreaded pin assembly of FIG. 1 forming a pin joint in a tent frame;

FIG. 7 is an enlarged perspective view of the unthreaded pin assembly of FIG. 1 forming the pin joint in a tent frame; and

FIG. 8 is a perspective view of the unthreaded, self-locking pin forming another pin joint in a tent frame.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and ingredients have not been described in detail so as not to obscure the invention defined by the claimed subject matter.

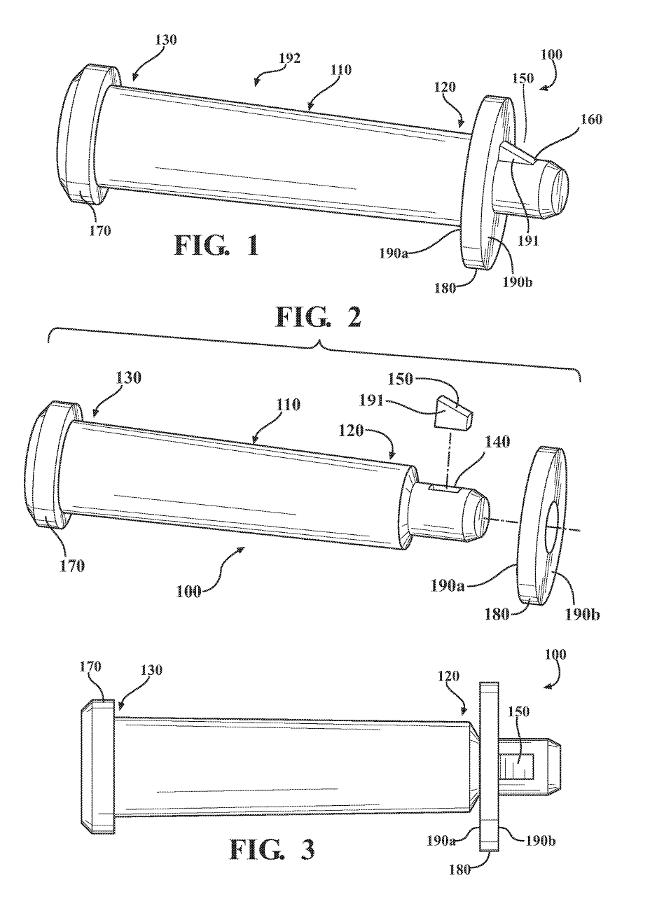

Referring to FIG. 1, FIG. 1 shows a perspective view of an exemplary embodiment of a pin assembly 100 according to the invention disclosed herein. The pin assembly 100 comprises an unthreaded, self-locking pin 192 including a generally cylindrical, elongated shaft 110 having a first end 120 and a second end 130. The second end 130 may have an enlarged head 170. As shown in FIG. 2, a hole 140 extends partway through the shaft 110 near the first end 120. A fin 150 is slidably disposed in the hole 140. The diameter of the first end 120 is smaller than the diameter of the second end 130 to improve the ease of removability of the unthreaded, self-locking pin 192 from an object.

In an exemplary embodiment, the fin 150 has a wedge-shaped portion 160 comprising a tapered edge that extends above the surface of the shaft 110 when the fin 150 is in its extended (non-depressed) position. The top surface of the fin 150 extends upwardly at an angle to create a ramped surface 191. The fin 150 sits upon a spring, such as a helical coil spring, a leaf spring, or a functionally equivalent spring, located inside the shaft 110. The unthreaded, self-locking pin 192 and the fin 150 may be made from any suitable materials such as, but not limited to, alloy steels, carbon steels, stainless steels, or aluminum alloys.

In an alternative embodiment, the fin 150 consists of a push button having an entirely flat portion extending above the surface of the shaft 110. In its extended position, the fin 150 may be readily depressed by a user's fingernail, instead of relying on the use of a tool. In this embodiment, the fin 150 is exposed enough above the shaft 110 to allow it to be depressed by the fingers/fingernails of most users.

In the embodiment shown in FIG. 1, the pin assembly 100 further comprises a washer 180 disposed on the first end 120 of the shaft 110, proximate to the fin 150. The washer 180 serves to limit the movement of the unthreaded, self-locking pin 192 when the unthreaded, self-locking pin 192 is inserted through an aperture in at least one object, while improving the ease of removability of the unthreaded, self-locking pin 192 from the aperture. The washer 180 comprises an outer diameter 190a that is larger than the diameter of the first end 120 of the shaft 110 and also larger than the diameter of apertures on objects that the unthreaded, self-locking pin 192 is being inserted through in order to ensure that the washer 180 does not move through the apertures.

The washer 180 further comprises an opening with an inner diameter 190b having the same diameter as that of the first end 120 of the shaft 110 and a smaller diameter than the diameter of apertures on objects through which the unthreaded, self-locking pin 192 is being inserted. As a result, the fin 150 is configured to engage with the washer 180 and retain the unthreaded, self-locking pin 192 in the apertures of the objects. In order to prevent the fin 150 from passing through the inner diameter 190b of the washer 180 without it being depressed by a user, the inner diameter 190b of the washer 180 must be smaller than the fin 150 in its extended position.

The washer 180 may be any type of washer such as, but not limited to a flat washer, fender washer, spherical washer, anchor plate, torque washer, cupped spring washer, curved disc spring, wave washer, split washer, tab washer, shoulder washer, keyed washer, or top hat washer. The washer 180 may be made from any suitable materials such as, but not limited to aluminum, copper, plastic, carbon steel, brass, titanium, iron, bronze, zinc, rubber, felt, leather, polyethylene, PTFE, or mica. In alternative embodiments, the pin assembly 100 does not comprise a washer, as shown in FIG. 8 below.

In other embodiments, the pin assembly comprises a self-locking fastener, a self-locking latch, a self-locking screw, a self-locking clasp, a self-locking snap, a self-locking bolt, or a functionally similar mechanism, instead of a self-locking pin.

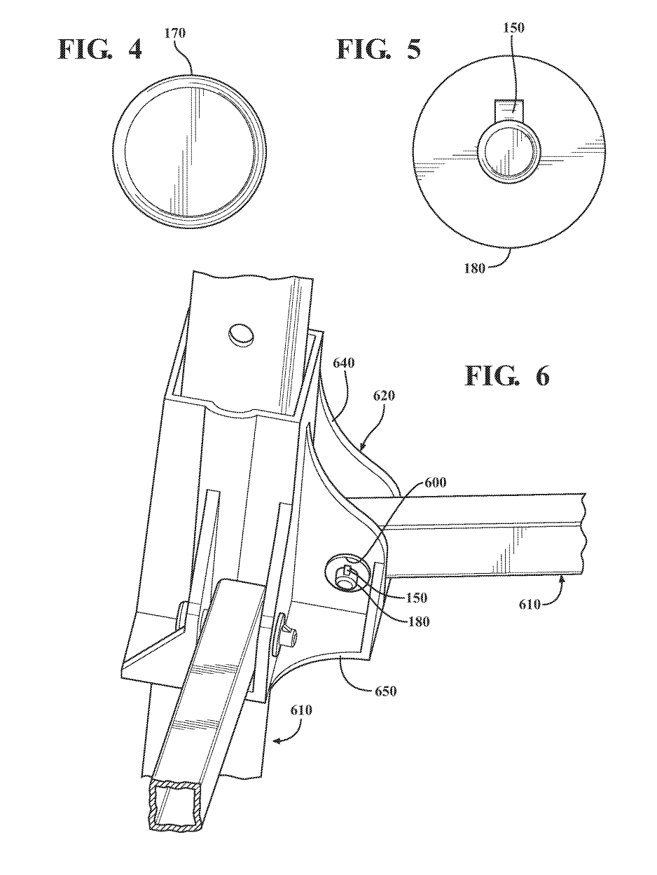

FIGS. 3-5 show top, second end 130, and first end 120 views, respectively, of the unthreaded pin assembly 100 of FIG. 1.

Referring to FIG. 6, FIG. 6 shows a perspective view of the pin assembly 100 of FIG. 1 forming a pin joint 600 in a tent frame. The pin joint 600 (also called a hinge joint) is a one degree of freedom kinematic pair that provides single-axis rotation function in a variety of objects such as, but not limited to door hinges, folding mechanisms, tent/canopy/shelter frames, and the like. The unthreaded, self-locking pin 192 is inserted through a least one aperture on a generally hollow, tubular first component 610 and at least one aperture on a second component 620. In some examples, the first component 610 is a space frame member made from hollow tubing. The aperture on the first component 610 is a cross aperture meant to accept the pin assembly 100.

In some examples, the second component 620 is a connector that physically couples with the end of at least one first component 610. The end of the first component 610 may be inserted into a slot formed by two substantially parallel pieces 640, 650 of the second component 620. In some examples, the apertures in the parallel pieces 640, 650 have the same width, diameter, and alignment as the aperture in the first component 610 in order to allow for easier insertion of the pin assembly 100. The unthreaded, self-locking pin 192 may be first inserted through the first parallel piece 640, then through the first component 610, and then through the second parallel piece 650.

The insertion of the unthreaded, self-locking pin 192 into both the first component 610 and the second component 620 forms the pin joint 600 and allows the first component 610 to pivot about its end in the second component 620. By physically engaging with the inner diameter 190b of the washer 180, the fin 150 maintains the unthreaded, self-locking pin 192 within the apertures of the first component 610 and the second component 620 during use of the pin assembly 100. The self-locking nature of the unthreaded, self-locking pin 192 allows for easy installation and integration into both the first component 510 and the second component 620. In other embodiments, the unthreaded, self-locking pin 192 may be inserted into and removed from more than two components.

The unthreaded, self-locking pin 192 may be removed from the first component 610 and the second component 620 by depressing the fin 150, removing the washer 180, and sliding the unthreaded, self-locking pin 192 out of the first component 610 and the second component 620. The fin 150 can be easily depressed by a user's fingernail, without the need for any special tools. The smaller diameter of the first end 120 of the unthreaded, self-locking pin 192 ensures that the fin 150 remains retracted below the shaft 110 and will not catch on the aperture in the first component 610 or the aperture in the second component 620 when in use. As a result, the unthreaded, self-locking pin 192 can be quickly and readily removed from the first component 610 and the second component 620 by a user, without the need for additional tools or components. Since the unthreaded, self-locking pin 192 does not become permanently inserted into the second component 620, the user will not be required to replace existing components when forming the pin joint 600.

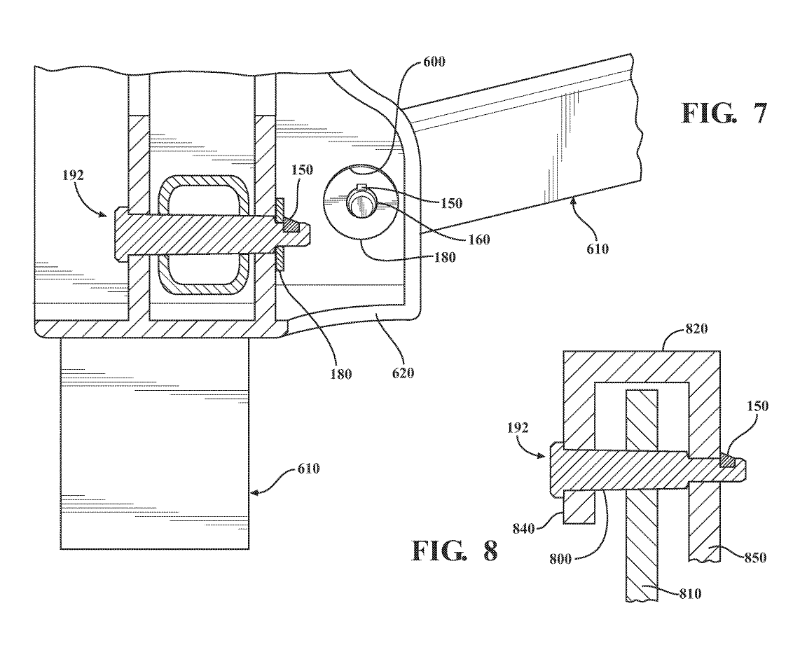

FIG. 7 shows an enlarged perspective view of the pin assembly 100 of FIG. 1 forming the pin joint 600 in a tent frame.

Referring to FIG. 8, FIG. 8 shows a perspective view of the unthreaded, self-locking pin 192 forming another pin joint 800 in a tent frame. In this embodiment, no washer is attached to the unthreaded, self-locking pin 192. The unthreaded, self-locking pin 192 is inserted through a least one aperture on a generally hollow, tubular first component 810 and at least one aperture on a second component 820. In some examples, the first component 810 is a space frame member made from hollow tubing.

In some examples, the second component 820 is a connector that physically couples with the end of at least one first component 810. The end of the first component 810 may be inserted into a slot formed by two substantially parallel pieces 840, 850 of the second component 820. The insertion of the unthreaded, self-locking pin 192 into both the first component 810 and the second component 820 forms the pin joint 800 and allows the first component 810 to pivot about its end in the second component 820. The fin 150 is exposed in its extended position after the unthreaded, self-locking pin 192 is inserted through the first component 810 and the second component 820.

In some embodiments, the last aperture that the fin 150 passes through during insertion of the unthreaded, self-locking pin 192 has a smaller diameter than the other apertures that the unthreaded, self-locking pin 192 previously passed through. In this embodiment, the unthreaded, self-locking pin 192 is first inserted through the first parallel piece 840, then passes through the first component 810, and then passes through the second parallel piece 850. As such, the aperture on the second parallel piece 850 has a smaller diameter than the diameters on the apertures of the first parallel piece 840 and the first component 810. In some embodiments, the unthreaded, self-locking pin 192 is inserted through two first components 810, which results in the formation of more than one pin joint 800, prior to passing through the second parallel piece 850.

In other embodiments, the second parallel piece 850 comprises at least one double diameter hole configured for insertion of the unthreaded, self-locking pin 192. The diameter of the double diameter hole is configured to match the diameter of the unthreaded, self-locking pin 192. In some examples, the diameter of the double diameter hole is a least about 0.125 inches. The diameter of the double diameter hole is adjustable based on the desired use of the unthreaded, self-locking pin 192 when forming pin joints in a variety of objects. Due to the presence of the double diameter hole, no washer is not required to secure the unthreaded, self-locking pin 192. By eliminating the washer, while still maintaining the desired functionality of the self-locking pin 192, a significant reduction in the amount of money, time, and labor is achieved through the use of the unthreaded, self-locking pin 192 to form pin joints in the assembly of collapsible structures, such as tents, canopies, shelters, and the like.

To remove the unthreaded, self-locking pin 192, the fin 150 is first depressed to pass through the last aperture through which the unthreaded, self-locking pin 192 passed during its insertion. In the embodiment shown in FIG. 8, the last aperture is on the second parallel piece 850 and has a double diameter hole. The fin 150 then passes through the remaining apertures, each having larger diameters than the aperture on the second parallel piece 850. Due to the larger diameters of the remaining apertures, the fin 150 may pass through these apertures in an extended (non-depressed) position.

Lastly, the unthreaded, self-locking pin 192 is slid out from the first component 810 and the second component 720.

In addition to the assembly of collapsible structures, such as pop up tents, inflatable tents, frame tents, pavilion tents, and canopies, the present invention may be applied to any structures/objects that include pin joints. It will, of course, be understood that, although particular examples have just been described, the claimed subject matter is not limited in scope to a particular example or limitation. Likewise, an example may be implemented in any combination of compositions of matter, apparatuses, methods or products made by a process, for example.

In the preceding description, various aspects of claimed subject matter have been described. For purposes of explanation, specific numbers, percentages, components, ingredients and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features and examples have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A pin assembly for forming a pin joint comprising:
an unthreaded, self-locking pin comprising:
a first end and a second end;
an elongated shaft;
a hole intersecting the shaft; and
a fin slidably disposed in the hole;
wherein the unthreaded, self-locking pin is configured to be readily inserted into and removed from an object, wherein the object comprises at least one first aperture on at least one first space frame member and at least one second aperture on at least one second space frame member, and wherein the first space frame member is pivotable about the second space frame member; and
wherein the fin is in its extended position after the unthreaded, self-locking pin is inserted through both the first space frame member and the second space frame member such that the unthreaded, self-locking pin is retained in the first aperture and the second aperture of the object.

2. The pin assembly of claim 1, wherein the unthreaded, self-locking pin is not permanently inserted into the second space frame member.

3. The pin assembly of claim 1, wherein the fin is configured to be depressed by a user's fingernail.

4. The pin assembly of claim 3, wherein the fin comprises a wedge-shaped portion extending upwardly at an angle from the hole to create a ramped surface.

5. The pin assembly of claim 3, wherein the fin comprises a substantially flat portion parallel to the surface of the shaft.

6. The pin assembly of claim 1, wherein the second end comprises an enlarged head portion.

7. The pin assembly of claim 6, wherein the diameter of the first end of the unthreaded, self-locking pin is smaller than the diameter of the second end.

8. The pin assembly of claim 1, wherein the first aperture on the first space frame member is a cross aperture.

9. The pin assembly of claim 1, wherein one of the first aperture or the second aperture is a double diameter hole, wherein the double diameter hole is the last aperture in the object through which the unthreaded, self-locking pin is inserted.

10. The pin assembly of claim 9, wherein the diameter of the double diameter hole is substantially the same as the diameter of the unthreaded, self-locking pin.

11. The pin assembly of claim 10, wherein the diameter of the double diameter hole is at least about 0.125 inches.

12. The pin assembly of claim 1, wherein the pin assembly further comprises a washer disposed on the first end, wherein the fin is configured to engage with the washer to retain the unthreaded, self-locking pin in both the first aperture and the second aperture.

13. The pin assembly of claim 12, wherein the washer comprises an outer diameter, wherein the outer diameter is larger than the diameter of the first aperture and the diameter of the second aperture.

14. The pin assembly of claim 13, wherein the washer comprises an inner diameter, where the inner diameter of the washer is smaller than the fin in its extended position, the diameter of the first aperture, and the diameter of the second aperture.

15. The pin assembly of claim 1, wherein the object is selected from the group consisting of a tent frame, a canopy frame, a shelter frame, a pavilion frame, an awning frame, and a door hinge.
